(19) United States
(12) Patent Application Publication
(10) Pub. No.: US 2018/0305032 A1
(43) Pub. Date: Oct. 25, 2018

(54) ENGINE ASSEMBLY FOR AN AIRCRAFT, COMPRISING A FRONT ENGINE MOUNT INCORPORATED WITH THE BOX OF THE MOUNTING PYLON

(71) Applicant: Airbus Operations SAS, Toulouse (FR)

(72) Inventors: Guillaume GALLANT, LAREOLE (FR); Olivier GLEIZE, TOULOUSE (FR)

(21) Appl. No.: 15/956,154

(22) Filed: Apr. 18, 2018

(30) Foreign Application Priority Data
Apr. 25, 2017 (FR) 1753606

(51) Int. Cl. B64D 27/26; F02C 7/20

(52) U.S. Cl. CPC B64D 27/26; B64D 27/12; F02C 7/20

(57) ABSTRACT

An engine assembly for an aircraft, comprising an engine mounting pylon comprising a primary structure forming a box closed by a front closing rib, a front engine mount comprising at least two connecting link rods that are disposed laterally on either side of the box and each comprise a first end mounted on a first fitting of the casing. The rib forms a part of the front mount, comprising at least one transverse fitting made in one piece so as to close a front end of the box and to have lugs protruding laterally on each side of the box, each lug being provided with a first orifice for mounting a second end of one of the link rods.

### CROSS-REFERENCES TO RELATED APPLICATIONS

This application claims the benefit of the French patent application No. 1753606 filed on Apr. 25, 2017, the entire disclosures of which are incorporated herein by way of reference.

### TECHNICAL FIELD

The present invention relates to the field of engine assemblies for aircraft comprising an engine, as well as a device for attaching the engine under a wing of that aircraft. One such attachment device is known from the document FR 3 014 840, for example.

It applies preferentially to commercial aircraft.

### BACKGROUND OF THE INVENTION

On existing aircraft, the engines such as turbofan engines are usually attached under the wings by complex attachment devices known as EMS (Engine Mounting Structure), or mounting pylon. The mounting pylons habitually employed have a primary structure, also termed a rigid structure. This rigid structure generally forms a box, i.e., is constructed by assembling upper and lower stringers connected to each other by a plurality of transverse stiffener ribs situated inside the box. The stringers are arranged as upper and lower faces while lateral panels close the lateral faces of the box. Angle brackets can provide the mechanical connection between these constituent elements of the primary structure of the pylon.

In a known manner, the primary structure of an attachment device is designed to enable the transmission to the wings of the static and dynamic forces generated by the engines, such as the weight, the thrust, or once again the various dynamic forces.

In the known prior art solutions, forces are conventionally transmitted between the engine and the primary structure by attachment means consisting of a front engine mount, a rear engine mount and a thrust force absorbing device. These elements generally form an isostatic attachment system.

The front engine mount generally comprises a main body to which are articulated connecting link rods, the other end of which is mounted on a fitting of the fan casing. The main body is pressed against the bottom of the front end of the box and fixed to the latter by bolts that pass through the sole plate of a front closing rib of the box. This arrangement comprises a plurality of parts that render it costly in terms of mass and overall size, in particular in the vertical direction.

There is therefore a need to optimize the design of the front engine mount, in order to reduce its mass and its overall size.

### SUMMARY OF THE INVENTION

To address this need, the invention comprises an engine assembly for an aircraft, comprising:
an engine comprising a fan casing extended rearwardly by an intermediate casing;
a pylon for mounting the engine under an aircraft wing, the pylon comprising a primary structure forming a box closed by a front closing rib;
means for attaching the engine to the primary structure of the mounting pylon, the attachment means comprising a front engine mount connecting the primary structure either to the fan casing or to the intermediate casing, the front engine mount comprising at least two connecting link rods that are disposed laterally one either side of the box, and each comprising a first end mounted on a first fitting of the casing.

According to the invention, the front closing rib forms part of the front engine mount comprising at least one one-piece transverse fitting so as to close a front end of the box and to feature lugs protruding laterally on each side of the box, each lug projecting laterally being provided with a first orifice for mounting a second end of one of the connecting link rods.

The invention is therefore noteworthy in that it simplifies the design of the front engine mount, producing a saving in terms of mass and overall size. In particular, the front engine mount has smaller dimensions in the vertical direction, thanks to the integration in one piece of at least a part of the front closing rib of the box and the part that in the prior art formed the attachment main body.

The invention has at least one of the following optional features, separately or in combination.

The one-piece transverse fitting also includes a lug projecting downwardly relative to the box, the lug projecting downwardly being provided with a second orifice for mounting a second fitting of the casing.

Each first mounting orifice and/or the second mounting orifice are oriented in a longitudinal direction X of the engine assembly.

According to a first preferred embodiment of the invention, the front closing rib also comprises, made in one piece with the transverse fitting, at least one of the following elements:
a first member for fixing the rib to an upper stringer of the box, the first fixing member projecting rearwardly from the top of the transverse fitting;
a second member for fixing the rib to a lower stringer of the box, the second fixing member projecting rearwardly from a lower part of the transverse fitting;
at least one third member for fixing the rib to one or more lateral panels of the box, each third fixing member projecting rearwardly from a side of the transverse fitting; and
one or more secondary structure support members projecting forwardly from the transverse fitting.

According to a second preferred embodiment, the front closing rib also comprises an additional one-piece transverse fitting superposed on the transverse fitting in a longitudinal direction X of the engine assembly, the two fittings being of substantially the same shape and fixed to each other, preferably by bolts.

In this second embodiment, the front closing rib preferably comprises a one-piece rear fixing fitting comprising at least one of the following elements:
a transverse platform superposed on the transverse fittings in the longitudinal direction X;
a first member for fixing the rib to an upper stringer of the box, the first fixing member projecting rearwardly from the top of the transverse platform;
a second member for fixing the rib to a lower stringer of the box, the second fixing member projecting rearwardly from the bottom of the transverse platform;
at least one third member for fixing the rib to one or more lateral panels of the box, each third fixing member projecting rearwardly from a side of the transverse platform.

The front closing rib preferably also comprises a one-piece front support fitting comprising one or more secondary structure support members projecting forwardly from a platform of this front support fitting.

Whichever embodiment is envisaged, the front engine mount is configured to absorb at least forces exerted in a transverse direction Y and in a vertical direction Z of the engine assembly.

The attachment means preferably also include a rear engine mount and lateral link rods for absorbing thrust forces.

The invention also comprises an aircraft comprising at least one such engine assembly.

Other advantages and features of the invention will become apparent in the following nonlimiting detailed description.

### BRIEF DESCRIPTION OF THE DRAWINGS

This description is given with reference to the appended drawings, in which:

FIG. 1 represents a side view of an aircraft comprising engine assemblies according to the invention;

FIG. 2 is a diagrammatic view in longitudinal section of an engine assembly according to the invention;

FIG. 2a is a sectional view of the primary structure of the pylon equipping the assembly shown in FIG. 2 taken along the line IIa-IIa in FIG. 2;

FIG. 3 is a diagrammatic perspective view of the engine of the assembly shown in the preceding figures, representing diagrammatically the absorption of forces by the attachment means;

FIG. 4 is a view in section taken along the line IV-IV in FIG. 7, showing the front engine mount in accordance with a first preferred embodiment of the invention;

FIG. 5 is a view in section taken along the line V-V in FIG. 4;

FIG. 6 is a view in section taken along the line VI-VI in FIG. 4;

FIG. 7 is a view in section taken along the line VII-VII in FIG. 4;

FIG. 8 represents a sectional view similar to that of FIG. 4, with the front engine mount conforming to a second preferred embodiment of the invention, this FIG. 8 corresponding to a view in section taken along the line VIII-VIII in FIG. 9; and

FIG. 9 is a view in section taken along the line IX-IX in FIG. 8.

### DETAILED DESCRIPTION OF THE PREFERRED EMBODIMENTS

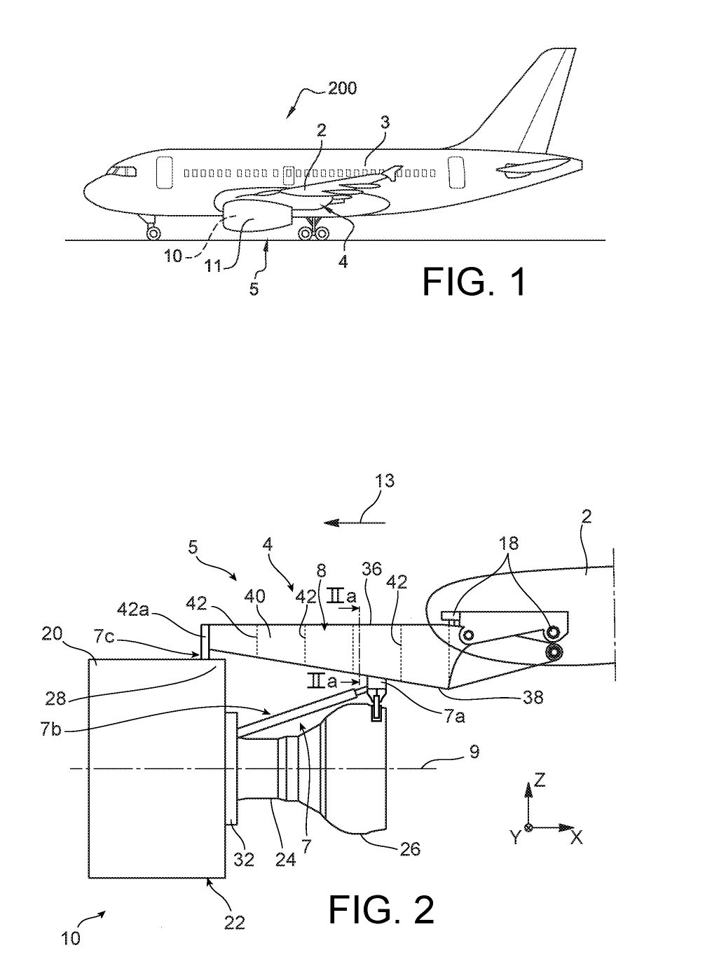

Referring to FIG. 1, there is represented an aircraft 200 comprising a fuselage 3 to which two wings 2 are fixed (only one is visible in FIG. 1), each wing carrying one or more engine assemblies 5 according to the invention. The engine assembly 5, also termed a propulsion assembly, includes a turbofan engine 10, such as a turbojet, a device 4 for attaching the engine 10, also known as a mounting pylon, as well as a nacelle 11 surrounding the engine. The engine assembly 5 is conventionally suspended under its wing 2.

Throughout the following description, by convention, the direction X corresponds to the longitudinal direction of the device 4 that is equally like the longitudinal direction of the turbojet 10 and that of the engine assembly 5, this direction X being parallel to a longitudinal axis 9 of this turbojet 10. On the other hand, the direction Y corresponds to the direction oriented transversely relative to the device 4 and equally like the transverse direction of the turbojet and that of the engine assembly 5, and the direction Z corresponds to the vertical direction or the height, these three directions X, Y and Z being mutually orthogonal.

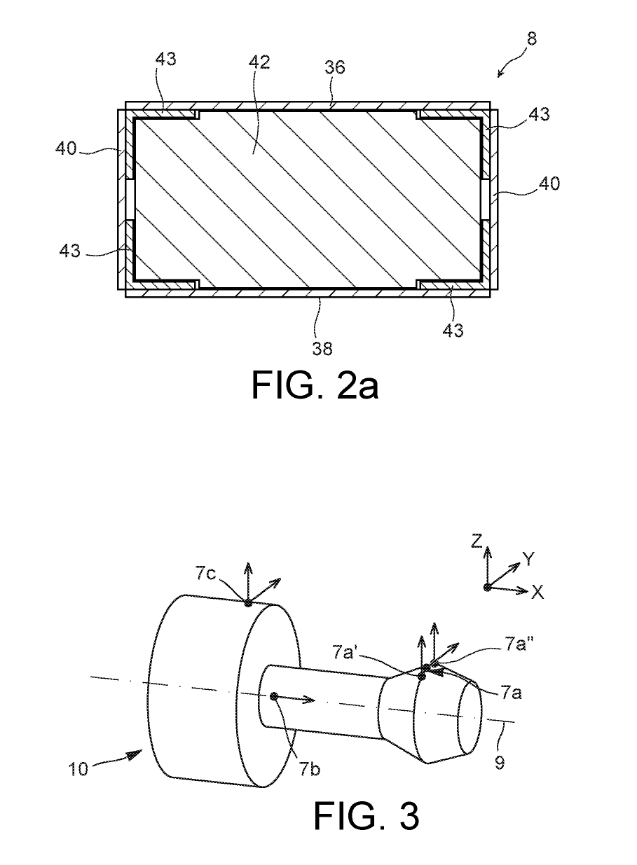

On the other hand, the terms “front” and “rear” are to be considered relative to a direction of forward movement of the aircraft as a consequence of the thrust exerted by the turbojets 10, this direction being represented diagrammatically by the arrow 13 in FIG. 2. Referring to that figure, the turbojet 10 includes an external structural envelope formed by various casings. These are, from front to rear, a fan casing 20, an intermediate casing 22, a central casing 24 and a gas ejection casing 26. The intermediate casing 22 comprises an exterior cowling 28 that is in line with and to the rear of the fan casing, with substantially the same diameter. This cowling 28 carries internally radial structural arms (not shown, also termed structural OGV) that are connected at their internal end to a hub 32 of the intermediate casing 22.

The engine assembly 5 also includes the mounting pylon of which the primary structure 8 is represented, but not the secondary structures intended to be mounted on this primary structure 8. These secondary structures are conventional and are not described in more detail hereinafter. They provide the segregation and the retention of the systems at the same time as supporting aerodynamic fairing elements.

The primary structure 8 forms a box, i.e., it is formed by an upper stringer 36 and a lower stringer 38 and two lateral panels 40 (only one can be seen in FIG. 2). These box elements are interconnected by interior transverse stiffener ribs 42, which are usually oriented in parallel planes YZ. These ribs are distributed in the box in the direction X. The rib 42a situated at the front end is called the front closing rib of the box. It is specific to the present invention, and is described in detail hereinafter. Referring to FIG. 2a, it should be noted that angle brackets 43 can also be arranged between the elements 36, 38, 40, so as to enable them to be fixed to one another. Alternatively, it is equally possible to provide a more “integrated” box design, in which the same part can form all or part of a plurality of these elements 36, 38, 40.

The primary structure box 8 is fixed to the wing 2 by conventional means 18, not described. Moreover, the engine 10 is attached to the box 8 under the wing by attachment means 7 preferably constituted of a front engine mount 7c, a rear engine mount 7a and a device for absorbing thrust forces formed by two lateral link rods 7b for absorbing thrust forces. The rear engine mount 7a connects the ejection casing 26 to the lower stringer 38 of the box. The front engine mount 7c is for its part specific to the present invention, and connects the front end of the box to the fan casing 20, or to the intermediate casing 22 to its rear and aligned with it. In this latter solution, the front engine mount 7c is more preferably connected to the exterior cowling 28 of this intermediate casing 22.

The attachment means 7 preferably form an isostatic force absorbing system. In fact, as shown diagrammatically in FIG. 3, the front engine mount 7c handles only the absorption of forces in the directions Y and Z, while the link rods 7b absorb only forces in the direction X. As for the rear engine mount 7a, this defines two lateral half-mounts 7a′, 7a″ arranged on respective opposite sides of the vertical median plane XZ. The first half-mount 7a′ is designed only to absorb thrust forces oriented in the direction Z, and the second half-mount 7a″ is designed to absorb only thrust forces oriented in the directions Y and Z. In this configuration, the forces exerted in the direction X are therefore absorbed by means of the link rods 7b, the forces exerted in the direction Y are absorbed by means of the front engine mount 7c and the second rear half-mount 7a″, while forces exerted in the direction Z are absorbed conjointly by means of the front engine mount 7c and the two rear half-mounts 7a′, 7a″.

On the other hand, the moment exerted in the direction X is absorbed vertically by means of the two rear half-mounts 7a′, 7a″, the moment exerted in the direction Y is absorbed vertically by means of these two half-mounts in conjunction with the front engine mount 7c, and the moment exerted in the direction Z is absorbed transversely by means of the second rear half-mount 7a″ in conjunction with the front engine mount 7c.

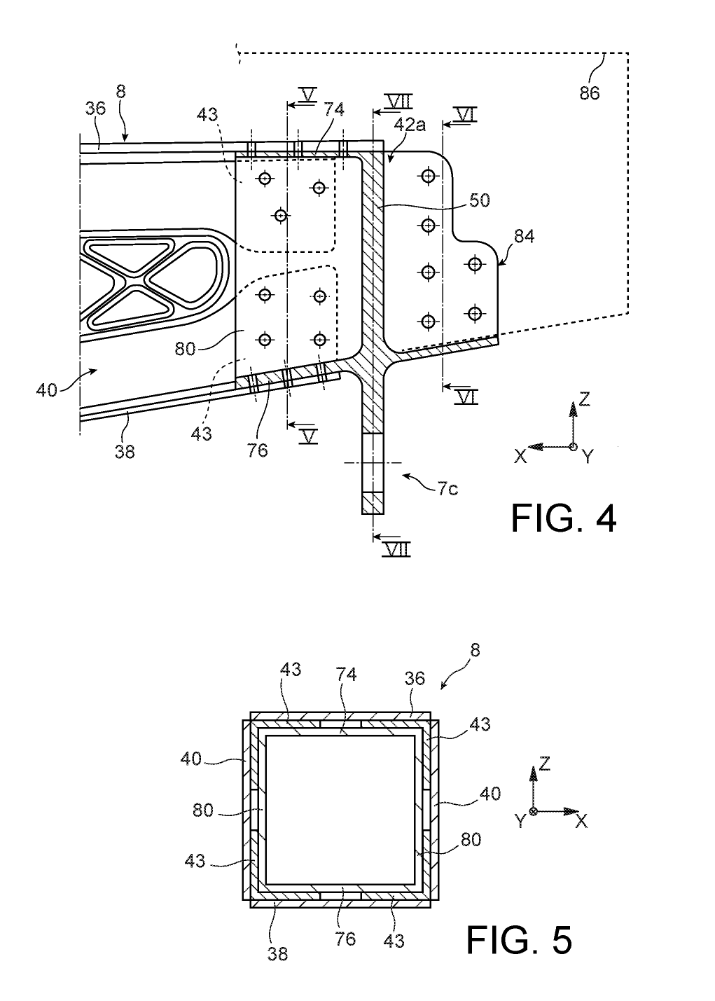

A first preferred embodiment of the front engine mount 7c is described next with reference to FIGS. 4 to 7. The mount 7c has the particular feature of being partially integrated into the primary structure 8 of the pylon, since the front closing rib 42a of the box is a component part of that mount 7c. To be more precise, in this first preferred embodiment, the front closing rib 42a is made in one piece, for example, die stamped. It comprises a plurality of elements made in one piece, including a transverse fitting 50 substantially oriented in the plane YZ. This transverse fitting 50 is such that it not only closes the front end of the box 8 but also has integral lugs for fixing other components of the mount 7c.

These are firstly two lugs 52 projecting laterally on each side of the box, in the direction Y. These two lugs 52 are preferably arranged symmetrically relative to the vertical median plane XZ of the engine assembly, represented by the section line IV-IV in FIG. 7. They therefore project laterally from the two lateral panels 40, extending outwardly and downwardly.

Each of these lugs takes the form of a single fitting, or a yoke, having through it a first mounting orifice 54 intended for the articulation of a connecting link rod 56 shown in FIG. 7. Each link rod 56 is situated laterally relative to the box 8, on either side of the latter. They are inclined so as to extend downwardly and laterally outwards. Each of them has a first end mounted on a first fitting 58 fastened to the fan casing 20, or to the exterior cowling 28 of the intermediate casing. The first two fittings 58 are therefore lugs projecting upwardly from the casing concerned. Each of them has passing through it a first shear axis 60 oriented in the direction X.

The other end of each of the two connecting link rods 56 is mounted in and articulated to the first mounting orifice 54 of the associated lug 52. A second shear axis 62, oriented in the direction X like the first orifice 54, passes through this same orifice 54 as well as the second end of the link rod 56.

On the other hand, the transverse fitting 50 is such that it also integrates a lug 64 projecting downwardly relative to the box. This lug 64, in the form of a single fitting or yoke, is intended to be mounted on and articulated to a second fitting 66 fastened to the associated casing 20, 28. To this end, a third shear axis 68 passes through a second orifice 70 of the lug 64 and the second fitting 66. This third shear axis 68 and likewise the second orifice 70 are oriented in the direction X.

Due to making the transverse fitting 50 and the lugs 52, 64 in one piece, the front mount has a lower mass because of the elimination on the one hand of the bolts usually employed and on the other hand of the increased thicknesses usually adopted for these bolts. The overall size is also reduced, which enables the engine to be moved closer to the pylon in the direction Z, and thus to increase the ground clearance. Moreover, fabrication is rendered easier because of the reduced number of component parts of the front mount 7c. Finally, the mechanical strength of the mount is also increased by this, which enables the integration of more powerful engines.

In this first preferred embodiment, the front closing rib 42a integrates other elements made in one piece with the transverse fitting 50.

Firstly, this refers to fixing members all extending rearwardly from the transverse fitting 50 and that together form a structure of substantially square or rectangular section, as shown in FIG. 5. These elements are situated in the interior of the primary structure 8, pressed against and fixed to the constituent elements of this primary structure. Fixing is effected in the conventional manner by rivets or by bolts, with diameters for example between 10 and 15 mm inclusive. These bolts/rivets (not shown) therefore pass through the fixing members described in detail hereinafter, the stringers 36, 38, the lateral panels 40 and the angle brackets 43.

They include a first member 74 for fixing the rib 42a to the upper stringer 36. This first fixing member 74 projects rearwardly from the top of the transverse fitting 50. There is also provided a second member 76 for fixing the rib 42a to the lower stringer 38, this second fixing member projecting rearwardly from a lower part of the transverse fitting 50. Finally, two third members 80 for fixing the rib 42a to the two lateral panels 40 are also provided, to cooperate two by two. Each third fixing member 80 projects rearwardly from a side of the transverse fitting 50.

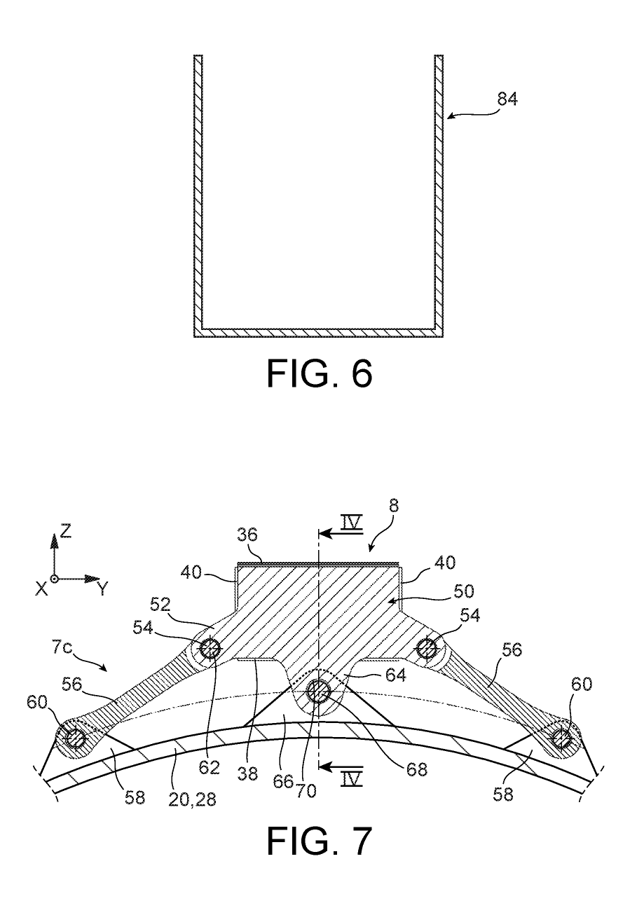

The front closing rib 42a finally integrates, in one piece with the transverse fitting 50 and the fixing members, one or more secondary structure support members. Here there is provided a support member 84 with a U-shaped section shown in FIG. 6, which projects forwardly from the transverse fitting 50. This member 84 supports for example an aerodynamic fairing 86 and/or systems such as cables.

For so-called “failsafe” safety reasons, the front closing rib 42a could be divided into two distinct parts, situated on respective opposite sides of the section plane diagrammatically indicated by the line VII-VII in FIG. 4. The transverse fitting 50 would therefore be divided into two superposed parts so that in the event of failure of one of them the other can absorb the forces for a particular time.

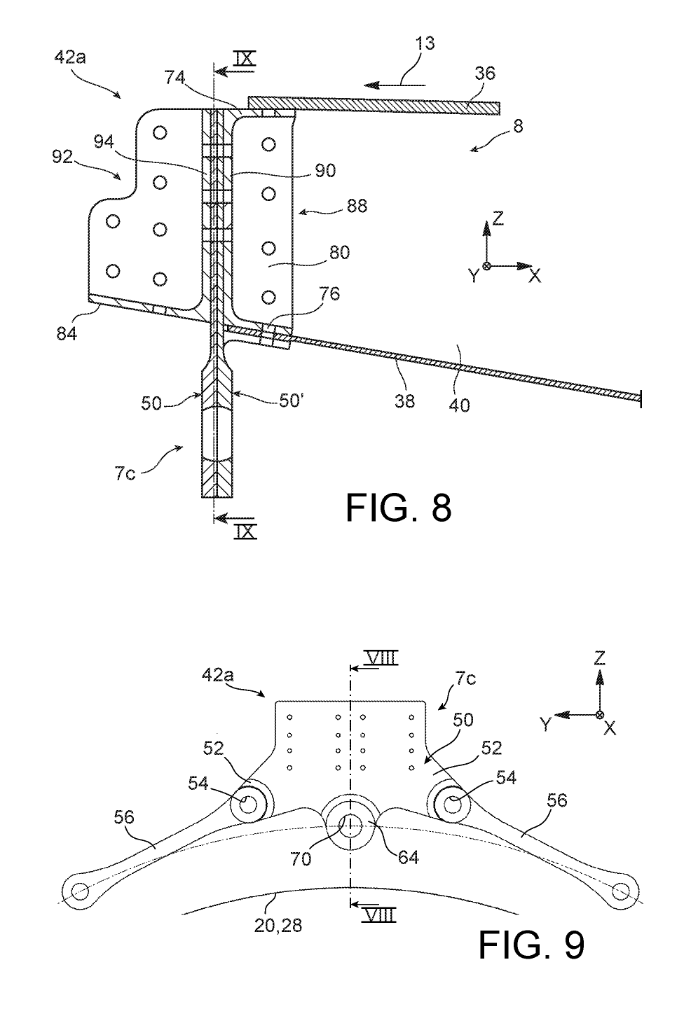

Accordingly, FIGS. 8 and 9 show a second preferred embodiment in which the front closing rib 42a has a shape substantially identical or similar to that of the first embodiment, while being produced in the form of a plurality of distinct parts fixed together, each made in one piece. Because of the similarities between the two embodiments, in the figures, the elements that bear the same reference numbers correspond to identical or similar elements.

The front closing rib 42a firstly comprises the transverse fitting 50, equipped with its lugs 52, 64. It is duplicated by an additional transverse fitting 50′ which is superposed on it in the direction X of the engine assembly. The two fittings 50, 50′ are of substantially the same shape and fixed to one another, preferably by bolts or rivets, for example with diameters between 10 and 15 mm inclusive. The additional fitting 50′, which is symmetrical to the transverse fitting 50 about a transverse plane XZ, has a so-called “failsafe” safety function enabling the passage and the transmission of forces coming from the engine, even in the event of failure of the fitting 50. Conversely, this “failsafe” function is also provided by the transverse fitting 50 in the event of failure of the additional transverse fitting 50′.

The rib 42a also includes, pressed against and fixed to the transverse fittings 50, 50′, a one-piece rear fixing fitting 88. This fitting 88 includes firstly a transverse platform 90 inscribed in a plane YZ and pressed against the additional transverse fitting 50′. The platform 90 has dimensions locally corresponding to the inside cross section of the box. From the top, bottom and sides of this platform 90 first, second and third fixing members 74, 76, 80 respectively extend rearwardly in one piece, being fixed to the elements of the box 8 in a manner identical or similar to that described in the context of the first embodiment.

Finally, the rib 42a also includes, pressed against and fixed to the transverse fittings 50, 50′, a one-piece front support fitting 92. This fitting 92 comprises firstly a transverse platform 94 inscribed in a plane YZ and pressed at the front against the transverse fitting 50. The platform 94 has dimensions locally corresponding to the interior cross section of the box. From this platform 94 extends a support member 84 with a U-shaped section, identical or similar to that of the first embodiment. As in that first embodiment, the member 84 supports, for example, an aerodynamic fairing 86 and/or systems such as cables.

It is to be noted that segmenting the rib 42a into a plurality of parts enables maintenance operations to be simplified, given that some of these parts can be demounted while the other parts of the rib can remain in place.

Of course, diverse modifications can be made by the person skilled in the art to the invention that has just been described by way of nonlimiting example only.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An engine assembly for an aircraft, comprising:
an engine comprising a fan casing extended rearwardly by an intermediate casing;
a pylon for mounting the engine under an aircraft wing, the pylon comprising a primary structure forming a box closed by a front closing rib;
means for attaching the engine to the primary structure of the mounting pylon, the attachment means comprising a front engine mount connecting the primary structure either to the fan casing or to the intermediate casing, the front engine mount comprising at least two connecting link rods that are disposed laterally one either side of the box, and each comprising a first end mounted on a first fitting of said fan casing or intermediate casing,
the front closing rib forming part of the front engine mount comprising at least one transverse fitting made in one piece so as to close a front end of the box and to feature lugs protruding laterally on each side of said box, each lug projecting laterally being provided with a first orifice for mounting a second end of one of the connecting link rods,
wherein the front closing rib also comprises, made in one piece with said transverse fitting, one or more secondary structure support members projecting forwardly from the transverse fitting.

2. The engine assembly according to claim 1, wherein the front closing rib also comprises, made in one piece with said transverse fitting and the one or more secondary structure support members, at least one of the following elements:
a first member for fixing the rib to an upper stringer of the box, said first fixing member projecting rearwardly from the top of the transverse fitting;
a second member for fixing the rib to a lower stringer of the box, said second member projecting rearwardly from a lower part of the transverse fitting; and
at least one third member for fixing the rib to one or more lateral panels of the box, each third fixing member projecting rearwardly from a side of the transverse fitting.

3. The engine assembly according to claim 1, wherein the front closing rib also comprises an additional one-piece transverse fitting superposed on the transverse fitting in a longitudinal direction of the engine assembly, the two fittings being of substantially the same shape and fixed to each other, preferably by bolts.

4. The engine assembly according to claim 3, wherein the front closing rib also comprises a one-piece rear fixing fitting comprising at least one of the following elements:
a transverse platform superposed on the transverse fittings in the longitudinal direction;
a first member for fixing the rib to an upper stringer of the box, said first fixing member projecting rearwardly from the top of the transverse platform;
a second member for fixing the rib to a lower stringer of the box, said second member projecting rearwardly from the bottom of the transverse platform;
at least one third member for fixing the rib to one or more lateral panels of the box, each third fixing member projecting rearwardly from a side of the transverse platform.

5. The engine assembly according to claim 1, wherein said one-piece transverse fitting also includes a lug projecting downwardly relative to the box, said lug projecting downwardly being provided with a second orifice for mounting a second fitting of said fan casing or intermediate casing.

6. The engine assembly according to claim 5, wherein each of at least one of the first mounting orifices or the second mounting orifices are oriented in a longitudinal direction of the engine assembly.

7. The engine assembly according to claim 1, wherein said front engine mount is configured to absorb at least forces exerted in a transverse direction and in a vertical direction of the engine assembly.

8. The engine assembly according to claim 1, wherein the attachment means also include a rear engine mount and lateral link rods for absorbing thrust forces.

9. An aircraft comprising at least one engine assembly according to claim 1.
